(19) United States
(12) Patent Application Publication
(10) Pub. No.: US 2017/0259406 A1
(43) Pub. Date: Sep. 14, 2017

(54) Clamping Device

(71) Applicant: DE-STA-CO Europe GmbH, Oberursel (DE)

(72) Inventor: Andreas NEBEL, Monchberg (DE)

(21) Appl. No.: 15/405,504

(22) Filed: Jan. 13, 2017

Related U.S. Application Data
(63) Continuation of application No. PCT/DE2015/100286, filed on Jul. 8, 2015.

(30) Foreign Application Priority Data
Jul. 15, 2014 (DE) 102014109897.8

(51) Int. Cl. B25B 5/16; G01D 5/20; B25B 5/08

(52) U.S. Cl. CPC B25B 5/16; B25B 5/087; G01D 5/20

(57) ABSTRACT

A clamping device has, comprising a drive (1) with a linearly movable actuator (2). A position monitoring device (3) detects the position of the actuator (2). A pivot member (4) is operatively connected to the actuator (2) and is rotatably mounted about an axis of rotation (8). The axis of rotation (8) is stationary with respect to the drive (1). The position monitoring device (3), for detecting the position of the actuator (2), is designed to cooperate with the pivot member (4).

### CROSS-REFERENCE TO RELATED APPLICATIONS

This application is a continuation of International Application No. PCT/DE2015/100286, filed Jul. 8, 2015, which claims priority to German Application No. 102014109897.8, filed Jul. 15, 2015. The disclosures of the above applications are incorporating herein by reference.

### FIELD

The present disclosure relates to a clamping device and, more particularly, to a clamping device with a position monitoring device that detects position of the actuator.

### BACKGROUND

A clamping device is known from the patent document DE 102 38 815 B3. This centring clamping device consists of a drive, in particular a piston drive, with a linearly movable actuator (piston rod). A position monitoring device detects the position of the piston rod (illustrated in an indicated manner on the left in FIG. 4 of this document). A pivot member, operatively connected with the piston rod, is rotatably mounted about a rotation axis that is stationary with respect to the drive.

Patent document EP 2 433 751 A2 illustrates a similar clamping device. Here, the rotation axis is mounted so as to be displaceable with respect to the drive within narrow limits. A further clamping device is known from the patent document EP 1 258 313 A2.

In the last two mentioned patents, EP 2 433 751 A2 and EP 1 258 313 A2, the pivot member is optionally designated as a lever element (see reference number 3 therein) or as an actuator (see reference number 5 therein). In these two solutions, as also in DE 102 38 815 B3, the position monitoring device, as can be seen from FIG. 4 of EP 2 433 751 A2 or respectively from FIG. 5 of EP 1 258 313 A2, is arranged laterally on the housing of the clamping device. It operates directly together with a position indicator arranged at the free end of the piston rod facing away from the piston drive.

For the sake of completeness, reference is also made to the more remote patent documents DE 88 11 579 U1, DE 90 16 781 U1, DE 198 24 579 C1, DE 199 06 641 A1, US 2004/0061268 A1, DE 10 2006 049 447 A1 and DE 20 2011 002 820 U1.

The disclosure is based on improving problems of the above described clamping device. In particular, a clamping device has an improved position detection. This problem is solved by a clamping device that comprises a drive with a linearly movable actuator. A position monitoring device detects the position of the actuator. A pivot member is operatively connected to the actuator and is rotatably mounted about an axis of rotation. The axis of rotation is stationary with respect to the drive. The position monitoring device, for detecting the position of the actuator, is designed to cooperate with the pivot member.

### SUMMARY

According to the disclosure, the position monitoring device, for detecting the position of the actuator, is designed to cooperate with the pivot member.

In other words, the disclosure is distinguished, in particular, in that the linear movement of the pivot member, or respectively in particular of the piston rod, is firstly transformed or respectively translated into a rotary movement of the pivot member. The rotary movement of the pivot member is only subsequently detected by the position monitoring device. This provision has the advantage that a relatively great movement of the pivot member is able to be generated from a relatively small movement of the actuator, or respectively in particular of the piston rod. This leads to an improved position detection with a constant measurement accuracy per se of the position monitoring device.

Other advantageous further developments of the clamping device according to the disclosure will emerge from the dependent claims and disclosure.

The clamping device according to the disclosure, including its advantageous further developments according to the dependent claims, is explained in further detail below with the aid of the illustration by drawings of two example embodiments.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a first embodiment of the clamping device in a fully opened position with an opening angle of 72°.

FIG. 2 is a top view of the clamping device according to FIG. 1 in fully opened position.

FIG. 3 is a top view of the clamping device of FIG. 1 in a partially opened position with an opening angle of 30°.

FIG. 4 is a side view of the clamping device according to FIG. 1 in a closed position.

FIG. 5 is a top view of the clamping device according to FIG. 4.

FIG. 6 is a side view of the clamping device according to FIG. 1 in a closed position.

FIG. 7 is a top view of the clamping device according to FIG. 6.

FIG. 8 is a side view of the clamping device according to FIG. 1 in a closed position.

FIG. 9 is a top view of the clamping device according to FIG. 8.

FIG. 10 is a perspective view of the clamping device according to FIG. 5.

FIG. 11 is a bottom view of the clamping device according to FIG. 5.

FIG. 12 is a perspective view of a second embodiment of the clamping device in a fully opened position.

FIG. 13 is a perspective view of the clamping device according to FIG. 12 in a partially opened or respectively partially closed position.

FIG. 14 is a side view of the clamping device according to FIG. 12 in a closed position.

### DETAILED DESCRIPTION

Hereafter, embodiments of the present disclosure will be specifically described with reference to the attached drawings.

The clamping device illustrated in the figures includes a drive 1 with a linearly movable actuator 2 and an operating position monitoring device 3. Preferably, the monitoring device 3 is electrically operated (in particular inductively, but also it may be pneumatically or electromechanically operated). The operating position monitoring device 3 detects the position of the actuator 2. A pivot member 4 is operatively connected with the actuator 2 and is rotatably mounted with respect to the drive 1. As already mentioned, the drive 1 includes a piston, movably mounted in a cylinder, and the actuator 2, constructed as a piston rod fastened to the piston. In addition, the pivot member 4 is rotatably mounted about a rotation axis 8. The rotation axis 8 is stationary with respect to the drive 1. This means that the position of the rotation axis 8 with respect to the drive 1 is the same at every instant in time.

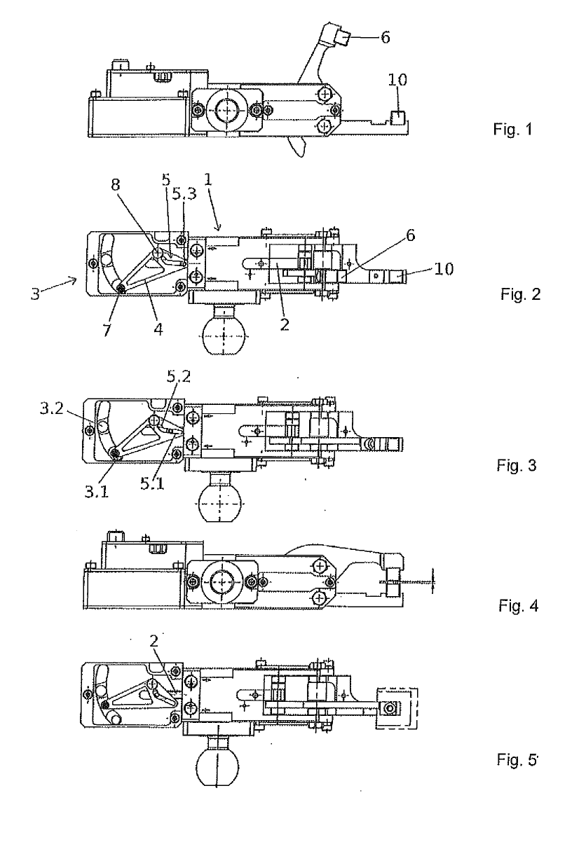

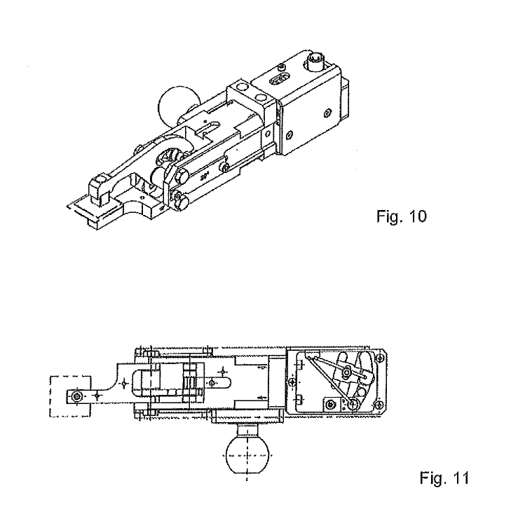

With regard to features of the mechanism of the embodiment according to FIGS. 1 to 11, which are already known for the sake of simplicity, reference is to be made to the previously mentioned patent document DE 20 2011 002 820 U1, However, it has a manual drive and not a piston drive, as can be seen. Otherwise, however, the actuation mechanism is comparable. The actuator 2 is connected, via a cam, with a pivot member which, in turn, has a clamping element 6 with an abutment 10. In this embodiment (see in this respect also FIGS. 4, 5, 6, 7, 10 and 11), a fixed workpiece is clamped between the clamping element 6 and the abutment 10.

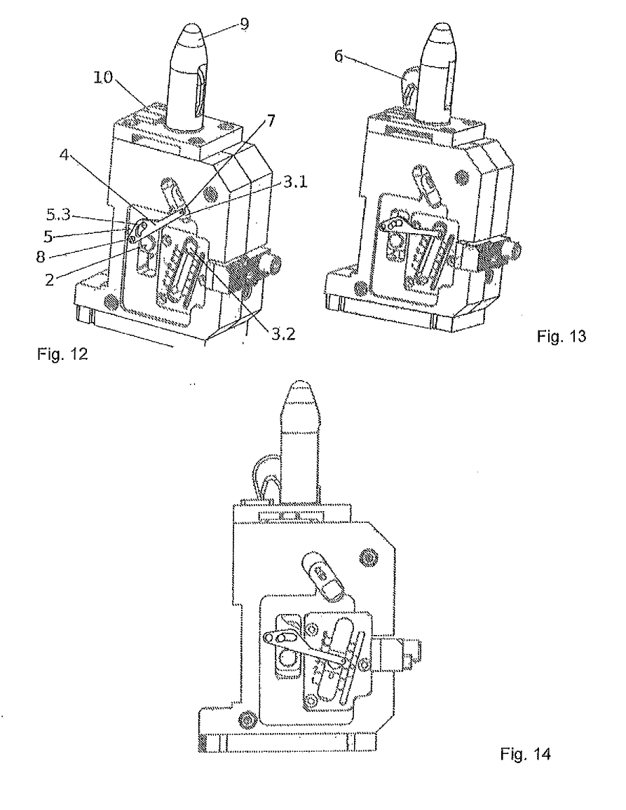

With regard to features of the mechanism of the embodiment according to FIGS. 12 to 14, which are already known, where the clamping device is constructed as a centring clamping device with a centring pin 9 and a clamping element 6 constructed as a clamping hook, for the sake of simplicity, reference is to be made to patent document EP 2 433 751 A2. Here, it can be seen at which location the drive (in particular piston drive), not illustrated in FIGS. 12 to 14 for the sake of clarity is arranged, at the end, facing away from the clamping element, of the housing receiving the pivot member.

It is now essential for all embodiments of the clamping device, according to the disclosure, that the position monitoring device 3, which detects the position of the actuator 2, is designed to cooperate with the pivot member 4.

Preferably, the actuator 2 and the pivot member 4 are operatively connected with one another via a cam guide 5. This cam guide 5 is formed from a guideway and from a guide element 5.3. The guide element 5.3 engages the guideway in a form-fitting manner. Preferably, the guideway is arranged on the pivot member 4 and the guide element 5.3 is arranged on the actuator 2. In addition, the cam guide 5 or respectively its guideway, as can be seen from the figures, has at least two guide sections 5.1, 5.2. The two guide sections 5.1, 5.2 are angled with respect to one another. The two guide sections 5.1, 5.2 are preferably constructed so as to pass continuously into one another.

The two guide sections 5.1, 5.2 provide a particular displacement of the actuator 2. When the guide element 5.3, coupled with the actuator 2, cooperates with the first guide section 5.1, a larger movement of the actuator 2 equates to a smaller movement of the pivot member 4. This is compared to a small displacement of the actuator 2, when cooperating with the second guide section 5.2, where a greater rotary movement of the pivot member 4 occurs.

The term “comparable” expresses that ultimately, with an identical adjustment travel length of the actuator 2 but at a different actuation position, a rotary movement of the pivot member 4 occurs with different extent results.

Furthermore, the cooperation of the actuator 2 with the first guide section 5.1 of the cam guide 5 is associated with an opened range or opened position of the clamping element 6. Cooperation of the actuator 2 with the second guide section 5.2 of the cam guide 5 is associated with a closed range or a closed position of the clamping element 6.

As can be seen, only an indirect connection exists between the pivot member 4 and the clamping element 6. The movement translation between the pivot member 4 and the clamping element 6 has quite deliberately no constant proportionality.

Preferably, the pivot member 4, which could also be designated as a pointer or the like, has a position indicator 7 that cooperates with the position monitoring device 3. The position indicator 7 is optionally constructed as a separate component on the pivot member 4 or as an integral component of the pivot member 4. In addition, the position monitoring device 3 has a detection region with two sensor elements 3.1, 3.2. Preferably, the sensor elements 3.1, 3.2 are constructed so as to be adjustable within the detection region to detect different positions of the position indicator 7 (see also FIG. 11 in this respect). Here, as will be explained more precisely further below, preferably, the detection region has four sub-regions. In two sub-regions, respectively, a sensor element 3.1, 3.2 is arranged. Also, between two sensor elements 3.1, 3.2, a further sub-region, designated as the intermediate sub-region, is arranged.

Furthermore, the position monitoring device 3 is connected with an electronic evaluating system that stores a chronological sequence of positions of the pivot member 4. By means of this, as will also be explained more precisely, it is possible to draw conclusions concerning the actual position of the actuator 2 and therefore ultimately concerning the clamping position.

With regard to the embodiment according to FIGS. 1 to 11, the pivot member 4 has a basic triangular shape. The rotation axis 8 is arranged at one apex corner. The cam guide 5 is arranged at a second apex corner. The position indicator 7 is arranged at a third apex corner. The position indicator 7 cooperates with the position monitoring device 3. In addition, the actuator 2 is constructed to project out from the drive 1 on both sides. In this case, the actuator 2 is constructed, on the one hand, to be operatively connected with a, or respectively, the clamping element 6. On the other hand, the actuator 7 is constructed to be operatively connected with the pivot member 4.

In accordance with FIGS. 1 to 11, the clamping device functions as follows:

Starting from the open position in FIGS. 1 and 2, the actuator 2 is situated in its rightmost position. The guide element 5.3, arranged on the actuator 2, is positioned at an outer end of the first guide section 5.1. If the actuator 2 is now moved toward the left, by preferably a pneumatically operating drive 1, the guide element 5.3 also shifts toward the left within the first guide section 5.1. Thus, the pivot member 4, due to the selected geometry of the cam guide 5, is caused to carry out a rotary movement in a clockwise direction. As the comparison of FIGS. 2 and 3 shows, the position indicator 7 moves out from the detection region of the one sensor element 3.1. Here, in this section of the cam guide 5, a relatively large movement of the actuator 2 leads to a comparatively small rotary movement of the pivot member 4.

If the actuator member 2 is moved still further toward the left, by mean of the drive 1, this leads (see FIG. 5) the guide element 5.3 to arrive into the constant transition region between the first and second guide section 5.1 and 5.2. In addition, the position indicator 7 arrives into the above-mentioned sub-region, arranged between the two sensor elements 3.1 and 3.2.

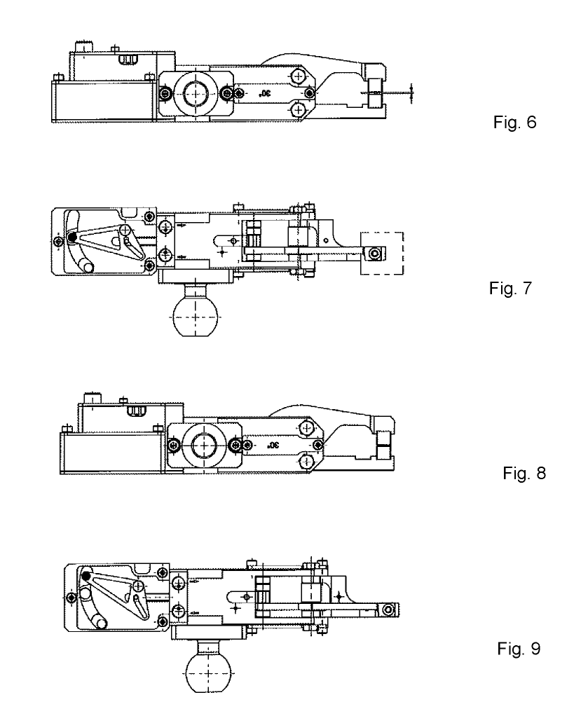

FIG. 5 shows a clamping position. Here, a so-called double sheet is positioned between the clamping element 6 and the abutment 10. A double sheet is to be understood here to mean a sheet that has double the thickness of a so-called single sheet, as is illustrated in FIGS. 6 and 7.

Now comparing FIGS. 5 and 7, it becomes clear that a further displacement of the actuator 2 toward the left, and thereby a displacement of the guide element 5.3 into the second guide section 5.2, results in a further, this time a distinctly greater, rotary movement of the pivot member 4. This displaces the position indicator 7 out from the intermediate sub-region into the other sub-region associated with the sensor element 3.2.

In FIG. 9, finally, the pivot member 4 is pivoted into the still remaining fourth sub-region. The sensor element 3.2 is arranged between the above-mentioned intermediate sub-region and this fourth sub-region.

It can be seen from the aforementioned explanations that it is possible with the aforementioned electronic evaluation system, to determine very precisely the respective position of the actuator 2 or, respectively, of the clamping element. Thus, even so precisely, the electronic evaluation system can differentiate, without difficulty, between a single sheet (see the position of the position indicator 7 in FIG. 7) and a double sheet (see the position of the position indicator 7 in FIG. 5). Thus, the clamping device, according to the disclosure, ultimately leads to an improvement in the measurement accuracy in the opening angle range relevant for the clamping device.

With regard to the embodiment according to FIGS. 12 to 14, the pivot member 4 has an elongate basic shape. The rotation axis 8 is arranged at one end. The position indicator 7 is arranged at another end. The position indicator 7 cooperates with the position monitoring device 3. The cam guide 5 is arranged between the position indicator 7 and the rotation axis 8.

Thus, in accordance with FIGS. 12 to 14, the clamping device functions as follows:

The clamping device, according to this embodiment, functions in an identical manner. The actuator 2, moved by the drive (not illustrated extra), brings about a pivoting of the pivot member 4 about axis 8. Also in this case, the cam guide 5, with a first and a second guide section 5.1 and 5.2, brings about rotation of the pivot member 4 at different extents in different movement sections of the actuator 2. Also, here a particularly sensitive detection of the position of the clamping element or, respectively, clamping hook is possible in the particularly relevant region shortly before the closed position.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

1. A clamping device comprising:
a drive having a linearly movable actuator;
a position monitoring device for detecting the position of the actuator;
a pivot member is operatively connected to the actuator;
the pivot member is rotatably mounted about a rotation axis that is stationary with respect to the drive; and
the position monitoring device, for detecting the position of the actuator, is designed to cooperate with the pivot member.

2. The clamping device according to claim 1,
wherein the actuator and the pivot member are operatively connected with one another, via a cam guide.

3. The clamping device according to claim 2,
wherein the cam guide includes at least two guide sections that are angled with respect to one another.

4. The clamping device according to claim 3,
wherein the guide sections are constructed to pass continuously into one another.

5. The clamping device according to claim 3,
wherein a particular displacement of the actuator in cooperation with the first guide section generates a smaller rotary movement of the pivot member than a comparable displacement of the actuator in cooperation with the second guide section which generate a greater rotary movement of the pivot member.

6. The clamping device according to
claim 3, wherein cooperation of the actuator with the first guide section of the cam guide is associated with a region of an open position of a clamping element and a cooperation of the actuator with the second guide section of the cam guide is associated with a region of a closed position of the clamping element.

7. The clamping device according to claim 1,
wherein the pivot member has a position indicator cooperating with the position monitoring device.

8. The clamping device according to claim 7,
wherein the position monitoring device has a detection region with two sensor elements that detect different positions of the position indicator.

9. The clamping device according to claim 8,
wherein the detection region has four sub-regions, in two sub-regions a respective sensor element is arranged, and between the two sensor elements a further sub-region is arranged.

10. The clamping device according to
claim 1, wherein the position monitoring device is connected to an electronic evaluation system, the electronic evaluation system storing a chronological sequence of positions of the pivot member.
